(19) United States
(12) Patent Application Publication
(10) Pub. No.: US 2022/0155634 A1
(43) Pub. Date: May 19, 2022

(54) SYSTEM AND METHOD TO SECURE A NARROW BORDERLESS DISPLAY PANEL WITHOUT COVER GLASS

(71) Applicant: DELL PRODUCTS, LP, Round Rock, TX (US)

(72) Inventors: Guantaek Oh, Paju (SG); Hyunseok Ko, Seochogu (SG)

(21) Appl. No.: 16/952,249

(22) Filed: Nov. 19, 2020

(51) Int. Cl. G02F 1/1335; G02F 1/1333

(52) U.S. Cl. CPC G02F 1/133528; G02F 1/133308; G02F 2201/50; G02F 2202/28; G02F 2001/133325

(57) ABSTRACT

A display device includes a display panel device, a frame, and a polarizer film. The frame is configured to hold the display panel device. The polarizer film is affixed to a surface of the display panel device. The polarizer film includes an extended portion extending beyond an outer edge of the display panel device. The extended portion is attached to the frame to retain the display panel device to the frame.

### FIELD OF THE DISCLOSURE

This disclosure generally relates to information handling systems, and more particularly relates to securing a narrow borderless display panel without cover glass in a display device.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A display device may include a display panel device, a frame, and a polarizer film. The frame is configured to hold the display panel device. The polarizer film may be affixed to a surface of the display panel device. The polarizer film may include an extended portion extending beyond an outer edge of the display panel device. The extended portion may be attached to the frame to retain the display panel device to the frame.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a cut-away diagram of a display device according to the prior art;

FIG. 2 is a cut-away diagram of a display device according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

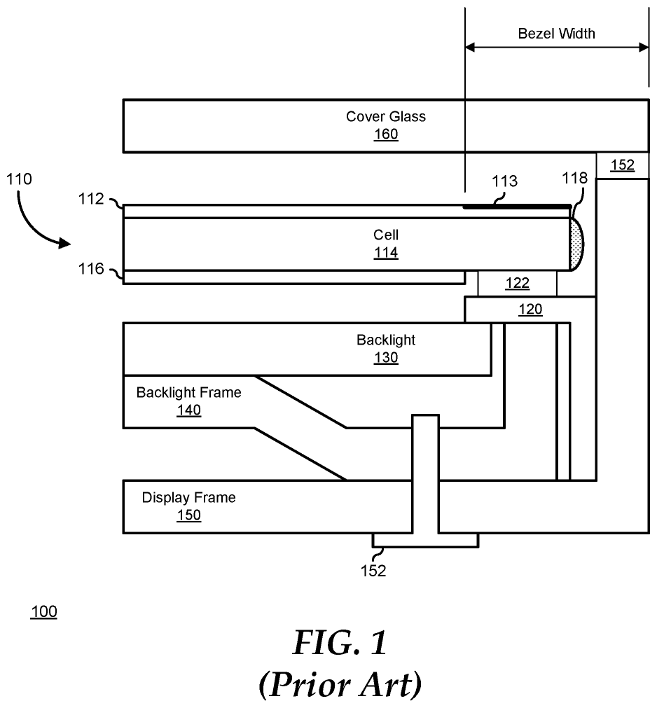

FIG. 1 illustrates a portion of a display device 100, as may be known in the prior art. Display device 100 represents a device for projecting visual information, and may include a computer monitor, an outdoor display device, a laptop or tablet display screen, a cellular phone device display screen, or other display device, as needed or desired. Note that, as illustrated, display device 100 is represented as a Liquid Crystal Display (LCD) display device, but this is not necessarily so. In particular, display device 100 may also represent a Light Emitting Diode (LED) display device such as an Organic LED (OLED) display device, a Plasma Display Panel (PDP) display device, a Quantum Dot LED (QLED) display device, or the like.

Display device 100 includes a display panel assembly 110, a panel subframe 120, a backlight assembly 130, a backlight frame 140, a display frame 150, and cover glass 160. Display panel assembly 110 represents a Liquid Crystal Display (LCD) device and includes a top polarizer film 112, a display panel device 114, a bottom polarizer film 116, and a side seal 118. Top polarizer film 112 includes a printed portion 113 on a bottom surface, that is, on a surface adjacent to display panel device 114. Printed portion 113 is a darkened portion of top polarizer film 112 that provides a distinct edge for display panel assembly 110. Display panel assembly 110 may be provided by a display manufacturer as an assembled unit, or display panel device 114 and polarizer films 112 and 116 may be provided separately, and assembled into the display panel assembly by a manufacturer of display device 100, as needed or desired. The details of display panel assembly 100, both in terms of its manufacture and use in projecting visual information are known in the art, and will not be further described herein, except as needed to illustrate the current embodiments.

Display panel assembly 110 is affixed to panel subframe 120 by a strip of double-sided tape 122 around the perimeter of the display panel assembly, and that adheres the bottom edge of the display panel assembly to the panel subframe. Backlight assembly 130 provides the light source for display panel assembly 110, and is affixed to backlight frame 140, and may further provide a mounting assembly for affixing panel subframe 120 to the backlight frame. Display frame 150 provides a rigid mounting structure for the assemblage of display panel assembly 110, panel subframe 120, backlight assembly 130, and backlight frame 140, and, as illustrated, is fastened to the backlight frame by a number of fasteners 152. The number, location, and type of fasteners 152 may be determined based upon design considerations for security, strength, durability, and the like, as may be known in the art. Cover glass 160 represents a tough outer protective surface for display device 100, and may be composed of a structural glass, a polymer, or the like, as needed or desired. Cover glass 160 is affixed to display frame 150 by a strip of double-sided tape 152 around the perimeter of the display frame, and that adheres to the bottom edge of the cover glass to the display frame. Side seal 118 is provided around the perimeter of display panel device 114 to narrow the gap between display panel device 114 and display frame 150, to mitigate the entry of foreign particles behind display panel assembly 110, and to eliminate light leakage out of the end of the display panel device. Display device 100 may include a back cover, not illustrated, into which the complete assemblage of display panel assembly 110, panel subframe 120, backlight assembly 130, backlight frame 140, display frame 150, and cover glass 160 are installed, as needed or desired.

Display device 100 is characterized as having a particular bezel width, that is, an area at the edge of the display device that is not usable for the projection of visual information. The bezel width is the width between the outer edge of display frame 150 and the inner edge of printed portion 113. Design trends for display devices such as display device 100 are focused on minimizing the bezel width in order to be able to mount multiple display devices together and provide a seamless visual display across the multiple display devices. In this regard, the width of the double-sided tape sealing surfaces (e.g., double-sided tape 122 and double-sided tape 152) dictate much of the bezel width, and design efforts have focused on reducing the width of such sealing surfaces. However, the reduction of the width of the sealing surfaces comes at a cost of reduced strength of the adherence of display panel assembly 110 to panel subframe 120 and of cover glass 160 to display frame 150. Further aggravating the problem of reduced adherence strength is the rise in popularity of display devices that are mounted in other than a vertical orientation. For example, control room applications may have stacked monitors with an upper row of monitors mounted at an angle optimized for upward viewing, and extreme gaming setups may have multiple monitors mounted at an angle optimized for a recumbent user. Here, the weight of display panel assembly 110 and of cover glass 160 may add an outward force, such that double-sided tape 122 and 152 experience a tensional force. Compounding the problem further is the trend toward larger display devices such that display panel assembly 110 and cover glass 160 become larger and heavier, increasing the load on the reduced sealing surfaces. Thus, an issue with cover glass and display panel assemblies pealing away from their mounting surfaces is becoming more common.

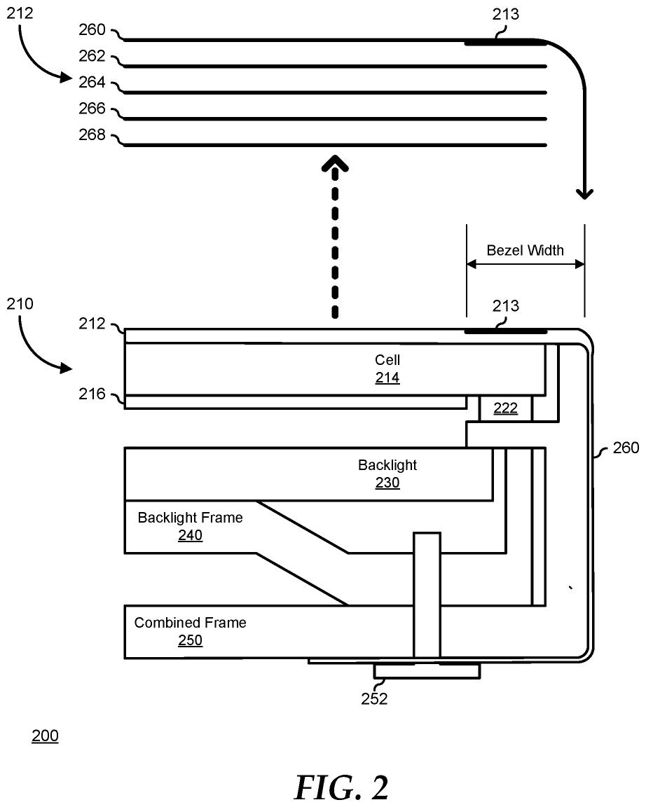

FIG. 2 illustrates a portion of a display device 200, according to an embodiment of the current disclosure. Display device 200 is similar to display device 100, representing a device for projecting visual information, and may include a computer monitor, an outdoor display device, a laptop or tablet display screen, a cellular phone device display screen, or other display device, as needed or desired. Display device 200 may represent a LCE display device, a LED display device, a PDP display device, a QLED display device, or the like, and the teachings of the present disclosure will be understood by the skilled artisan to be broadly adaptable to various display device technologies, as needed or desired.

Display device 200 includes a display panel assembly 210, a backlight assembly 230, a backlight frame 240, and a combined frame 250. Display panel assembly 210 is similar to display panel assembly 110, and includes a top polarizer film 212, a display panel device 214, and a bottom polarizer film 216. Top polarizer film 212 includes a printed portion 213 on a bottom surface, that is, on a surface adjacent to display panel device 214. Display panel assembly 210 may be provided by a display manufacturer as an assembled unit, or display panel device 214 and polarizer films 212 and 216 may be provided separately, and assembled into the display panel assembly by a manufacturer of display device 200, as needed or desired. The details of display panel assembly 200 are known in the art, and will not be further described herein, except as needed to illustrate the current embodiments.

Display panel assembly 210 is affixed to combined frame 220 by a strip of double-sided tape 222 around the perimeter of the display panel assembly, and that adheres the bottom edge of the display panel assembly to the combined frame. Backlight assembly 230 provides the light source for display panel assembly 210, and is affixed to backlight frame 240. Combined frame 250 provides a rigid mounting structure for the assemblage of display panel assembly 210, backlight assembly 230, and backlight frame 240, and, as illustrated, is fastened to the backlight frame by a number of fasteners 252. The number, location, and type of fasteners 252 may be determined based upon design considerations for security, strength, durability, and the like, as may be known in the art. Display device 200 may include a back cover, not illustrated, into which the complete assemblage of display panel assembly 210, backlight assembly 230, backlight frame 240, and combined frame 250 are installed, as needed or desired.

Here, polarizer film 212 is illustrated in greater detail as including a top protective layer 260, a polarizer layer 264 sandwiched between polarizer protective layers 262 and 266, and an adhesive layer 268. Top protective layer 262 represents a tough, durable, and scratch resistant material, such as a polyethylene terephthalate (PET) film, a thermoplastic polyreuthane (TPU) film, or the like. Polarizer layer 264 represents a polarizing material, such as a polyvinyl alcohol (PVA) film or the like. Polarizer protective layers 262 and 266 represent a material that enhances the optical qualities of polarizer film 212, and can include a tri-acetyl panelulose (TAC) film. Adhesive film 268 represents a pressure sensitive adhesive (PSA) material that adheres polarizer film 212 to the top surface of display panel device 214. In a particular embodiment, printed portion 213 is provided on the bottom surface of top protective layer 260. In another embodiment, printed portion 213 is provided on one or more of protective layers 262 and 266, polarizer layer 264, and adhesive layer 268. The details of fabricating polarizer film 212 are known in the art, and will not be further described herein, except as needed to illustrate the present embodiments.

Here, top protective layer 260 is shown as extending beyond the end of polarizer protective layers 262 and 266, polarizer layer 264, and adhesive layer 268, extending down around the side and bottom of combined frame 250, being fastened to the bottom of the combined frame by fastener 252. Thus, in addition to the retention of display panel assembly 210 to combined frame 250 by double-sided tape 222, the display panel assembly is further affixed to the combined frame through the extension of protective layer 260 down around the side and bottom of the combined frame and through the fastening of the protective layer with fastener 252. As a result of the additional adhesive strength provided by protective layer 260, double-sided tape 222 can be narrower than double-sided tape 122. Moreover, protective film 260 provides the tough outer protective surface to display device 200, similar to cover glass 160, additional cover glass is not needed in display device 200. As such, combined frame 250 does not need to be designed to retain cover glass, and so can be thinner than display frame 150 of display device 100.

Moreover, because top protective layer 260 is extended beyond display panel device 214 to combined frame 250, the need for a side seal similar to side seal 118 of display device 100 is eliminated. In particular, the tolerance between display panel assembly 210 and combined frame 250 can be tighter, making the gap between the display panel assembly and the combined frame more consistent. Further, any gap that exists is covered by top protective layer 260, and so foreign particles are prevented from getting behind display panel assembly 210. A further result of the reduced gap is the fact that less light leakage is visible. In consequence of these advantages, the bezel width of display device 200 is further reduced as compared with the bezel width of display device 100. In particular, the adhesion surface of display panel assembly 210 is reduced because the width of double-sided tape 222 is reduced, the gap between the display panel assembly and combined frame 250 is reduced due to the absence of a side seal, and the width of the combined frame is reduced as compared with the width of display frame 150 of display device 100.

In a particular embodiment, one or more of polarizer protective layers 262 and 266, polarizer layer 264, and adhesive layer 268 are extended beyond the edge of display panel device 214 to a similar extend as top protective layer 260. Here, it may be understood that the tension experienced by top protective layer 260 alone, as described above, may be such as to stretch or tear the top protective layer, while the additional strength afforded by the extension of one or more of polarizer protective layers 262 and 266, polarizer layer 264, and adhesive layer 268 may be sufficient to mitigate any ill consequences of extending top protective layer 260 alone. In particular, if adhesive layer 268 is extended, the adhesion of polarizer film 212 to the side and bottom of combined frame 250 further strengthens the adhesion of display panel assembly 210, and may mitigate any need for affixing the polarizer film with fastener 252.

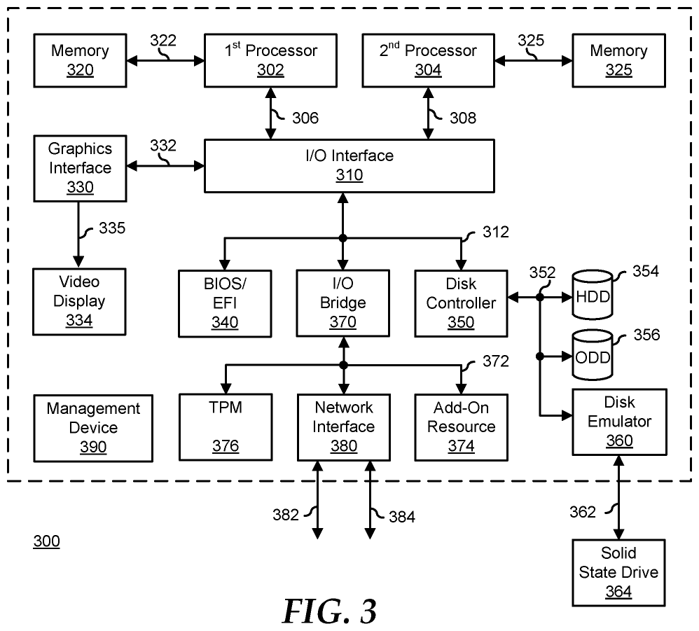

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device, comprising:
a display panel device;
a frame configured to hold the display panel device; and
a polarizer film affixed to a first surface of the display panel device, the polarizer film including an extended portion extending beyond an outer edge of the display panel device, wherein the extended portion is attached to the frame to retain the display panel device to the frame.

2. The display device of claim 1, wherein the extended portion is attached to the frame by a fastener.

3. The display device of claim 1, wherein the polarizer film includes a first layer of polarizing material adjacent to the first surface, and a second layer of protective material opposite to the first surface.

4. The display device of claim 3, wherein the extended portion includes only the second layer.

5. The display device of claim 3, wherein the polarizer film includes a third layer of adhesive material, wherein the polarizer film is affixed to the first surface by the third layer.

6. The display device of claim 5, wherein the extended portion includes the second layer and the third layer.

7. The display device of claim 6, wherein the extended portion is attached to the frame by the third layer.

8. The display device of claim 1, wherein a second surface of the display panel is affixed to a mounting surface of the frame.

9. The display device of claim 8, wherein the second surface is affixed to the mounting surface by a strip of double-sided adhesive tape.

10. A method, comprising:
inserting a display panel device into a frame configured to hold the display panel device;
affixing a polarizer film to a first surface of the display panel device, the polarizer film including an extended portion extending beyond an outer edge of the display panel device; and
attaching the extended portion to the frame to retain the display panel device to the frame.

11. The method of claim 10, wherein the extended portion is attached to the frame by a fastener.

12. The display device of claim 10, wherein the polarizer film includes a first layer of polarizing material adjacent to the first surface, and a second layer of protective material opposite to the first surface.

13. The display device of claim 12, wherein the extended portion includes only the second layer.

14. The display device of claim 12, wherein the polarizer film includes a third layer of adhesive material, wherein the polarizer film is affixed to the first surface by the third layer.

15. The display device of claim 14, wherein the extended portion includes the second layer and the third layer.

16. The display device of claim 15, wherein the extended portion is attached to the frame by the third layer.

17. The display device of claim 10, wherein a second surface of the display panel is affixed to a mounting surface of the frame.

18. The display device of claim 8, further comprising:
affixing the second surface to the mounting surface by a strip of double-sided adhesive tape.

19. A display device, comprising:
a display panel device;
a frame configured to hold the display panel device; and
a polarizer film affixed to a first surface of the display panel device, the polarizer film including an extended portion extending beyond an outer edge of the display panel device, wherein the extended portion is attached to the frame to retain the display panel device to the frame by a fastener, and wherein a second surface of the display panel is affixed to a mounting surface of the frame by a strip of double-sided adhesive tape.

20. The display device of claim 19, wherein the polarizer film includes a first layer of polarizing material adjacent to the first surface, and a second layer of protective material opposite to the first surface, and wherein the extended portion includes only the second layer.
